(19) United States
(12) Patent Application Publication
(10) Pub. No.: US 2010/0231729 A1
(43) Pub. Date: Sep. 16, 2010

(54) METHOD OF CAPTURING IMAGE AND ACCESSING CAPTURED IMAGE VIA NETWORK, COMPUTER PROGRAM OF ACCESSING CAPTURED IMAGE AND IMAGE CAPTURING APPARATUS THEREOF

(76) Inventor: Hsin-Chen Robin Lee, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/702,181

(22) Filed: Feb. 8, 2010

(30) Foreign Application Priority Data
Mar. 10, 2009 (TW) 098107661

(51) Int. Cl. H04N 5/225; H04N 5/76

(52) U.S. Cl. 348/207.11; 348/231.2; 348/E05.024; 348/E05.031

(57) ABSTRACT

A method of capturing image file and accessing captured image file via a network is provided. The method is employed in an image capturing apparatus which has a storage and is connected to the network. The method of capturing image and accessing captured image via the network includes: receiving a network scan instruction to initialize an image capturing operation; receiving an identification code corresponding to an image file to initialize an image accessing operation. The image capturing operation includes: scanning a document to generate the image file and storing the image file in the storage; and receiving the identification code corresponding to the image file and storing the identification code in the storage. The image accessing operation includes: searching for the identification code; and transmitting the image file corresponding to the identification code via the network.

### BACKGROUND OF THE INVENTION

1. Field of the Invention

The present invention relates to an image processing mechanism, particularly to a method of capturing an image and accessing the captured image via a network, a computer program and an image capturing apparatus of accessing the captured image.

2. Description of the Prior Art

For most network scanning methods in the present time, users are required to install a specific application program at a user's terminal device (e.g., a personal computer), and to further use the specific application program to register in a specific multi-function printer/web scanner, and then to activate a network sharing function of a specific file folder at the user's terminal device to store a scanned file. Before using the web scanning function, it must be assured first that the user's personal computer has been registered in the desired multi-function printer/web scanner and the specific application program is activated, and then the user(s) selects the personal computer in use at the multi-function printer/web scanner and inputs a code, thereby the multi-function printer/web scanner starts scanning and transmits the scanned image to the assigned file folder in the personal computer to complete the scanning procedure.

According the aforementioned conventional scanning procedure, the users must register in a multi-function printer/web scanner via a specific program. However, in a small network (e.g., a LAN network), there might be many users who register in the multi-function printer/web scanner at the same time and thus leading to an obstacle for selecting the desired computer at the multi-function printer/web scanner. Besides, for storing the scanned image files, the users must activate a sharing function of a file folder at a personal computer, leading to a loophole in network security.

### SUMMARY OF THE INVENTION

In light of this, the present invention brings out a method of capturing an image and accessing the captured image via a network, a computer program and an image capturing apparatus of accessing a captured image, the essence of the present invention is to simplify the procedure of network scanning and accessing scanned image files, and to provide a more solid security in data transmission.

According an embodiment of the present invention, a method of capturing an image file and accessing the captured image via a network, for an image file capturing apparatus which has a storage and is connected to the network, is disclosed. The method comprises: receiving a network scan instruction to initialize an image capturing operation; receiving an identification code corresponding to an image file via the internet to initialize an image accessing operation. The image capturing operation comprises: scanning a document and generating an image file and storing the image file in the storage; receiving the identification code corresponding to the image file; and storing the identification code in the storage. The image accessing operation comprises: searching for the identification code; and transmitting the image file corresponding to the identification code via the network.

According to another embodiment of the present invention, a computer program of accessing a captured image is disclosed. The computer program is loaded via a terminal device to executing the following steps: instructing the terminal device to receive an identification code; instructing the terminal device to send an identification code searching instruction to at least one image capturing apparatus connected to the terminal device via a network; instructing the at least one image capturing apparatus to search for the identification code stored therein by the identification code searching instruction; instructing one of the at least one image capturing apparatus to transmit an image file corresponding to the identification code; instructing the terminal device to receive the image file corresponding to the identification code.

According to another embodiment of the present invention, an image capturing apparatus is disclosed. The image capturing apparatus comprises: a storage, an image capturing module, a control module. The image capturing module, coupled to the storage, is for capturing an image of a document to generate an image file and thereby store the image file in the storage. The control module, coupled to the storage, is for receiving an identification code corresponding to the image file and storing the identification code in the storage, and then the control module uses the identification code to search for the image file corresponding to the identification code, and thereby transmits the image file corresponding to the identification code via a network.

Comparing with the prior art method, the users no longer need to suffer from the complicated setting and there is no need to activate a sharing function of a file folder at the personal computer, leading to a significant improvement in utility convenience and security.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an image capturing apparatus connected to a terminal device via a network according to an embodiment of the present invention.

FIG. 2 is a flowchart of an image capturing method according to the present invention.

FIG. 3 is a flowchart of an image accessing method via a network according to the present invention.

### DETAILED DESCRIPTION

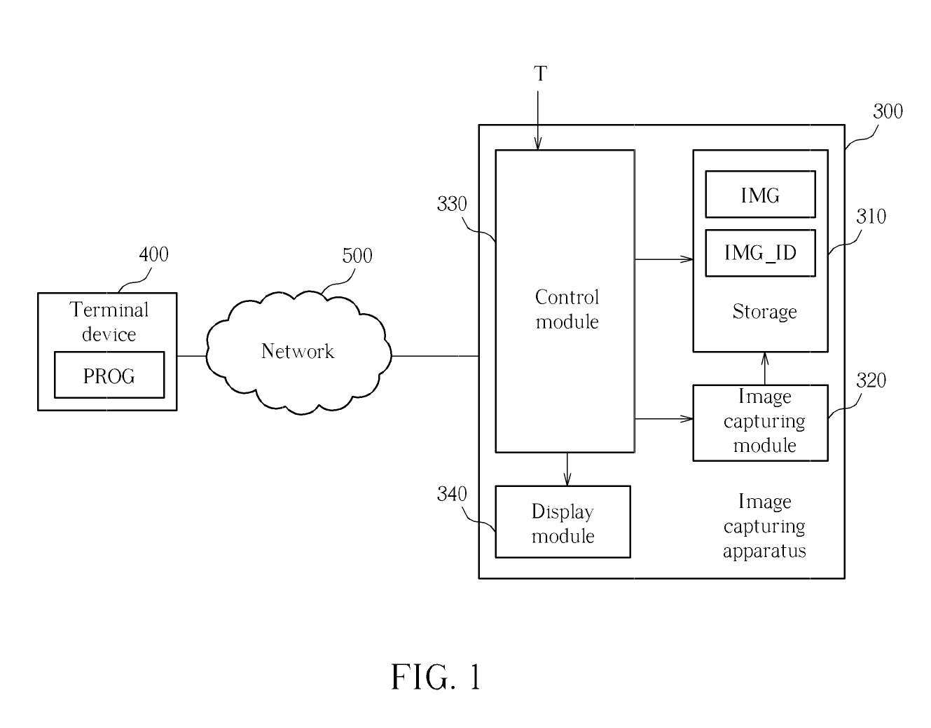

Please refer to FIG. 1. FIG. 1 is a diagram of an image capturing apparatus 300 connected to a terminal device 400 via a network 500 according to an embodiment of the present invention. In this embodiment, the image capturing apparatus 300 (e.g., a web scanner or any electronic apparatus capable of network scanning) includes: a storage 310, an image capturing module 320, a control module 330 and a display module 340. The image capturing module 320, coupled to the storage 310, is for capturing an image of a document to generate an image file IMG and storing the image file IMG in the storage 310. The control module 330, coupled to the storage 310, is for receiving an identification code IMG_ID corresponding to the image file IMG and storing the identification code IMG_ID in the storage 310, thereby using the identification code IMG_ID to search for the image file IMG corresponding to the identification code IMG_ID, and transmitting the image file IMG corresponding to the identification code IMG_ID to the terminal device 400 via the network 500. The display module 340 displays a message of insufficient storage space on the display module 340 when there is no sufficient space in the storage 310 for the image file IMG. In a preferred embodiment, the image capturing apparatus 300 is a scanner and the storage 310 is a storage unit established within the scanner.

In FIG. 1, the terminal device 400 communicates with the image capturing apparatus 300 via the internet 500 to execute an image capturing and accessing process. The operation process is detailed in the following description.

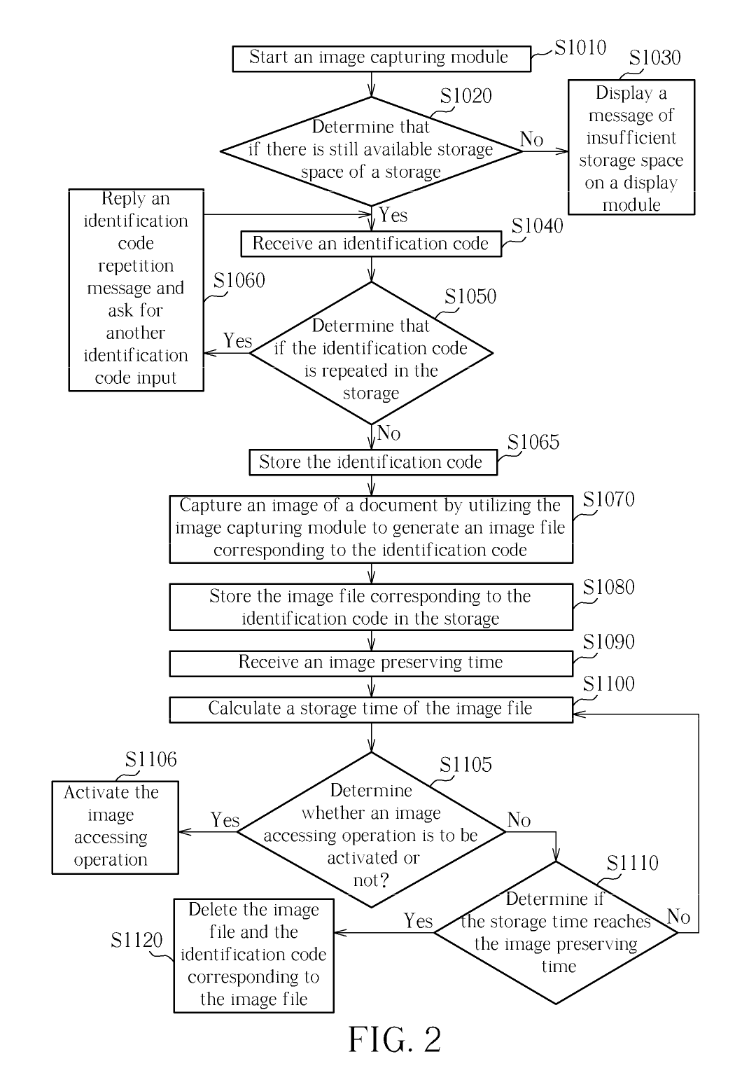

Please refer to FIG. 2. FIG. 2 is a flowchart of an image capturing method according to the present invention. If the result is substantially the same, the steps are not required to be executed in the exact order shown in FIG. 2. In addition, the steps in FIG. 2 are not required to be executed sequentially, i.e., other steps can be inserted in between. The steps of image capturing method according to the present invention are detailed as follows:

S1010: Start an image capturing module;

S1020: Determine that if there is still available storage space of a storage. If yes, go to step S1040; otherwise, go to step S1030;

S1030: Display a message of insufficient storage space on a display module;

S1040: Receive an identification code;

S1050: Determine that if the identification code is repeated in the storage. If yes, go to step S1060; otherwise, go to step S1065;

S1060: Reply an identification code repetition message and ask for another identification code input again, then go back to step S1040;

S1065: Store the identification code;

S1070: Capture an image of a document by utilizing the image capturing module to generate an image file corresponding to the identification code;

S1080: Store the image file corresponding to the identification code in the storage;

S1090: Receive an image preserving time;

S1100: Calculate a storage time of the image file;

S1105: Determine if an image accessing operation is to be activated or not. If yes, go to step S1106; otherwise, go to step S1110;

S1106: Activate an image accessing operation;

S1110: Determine if the storage time reaches the image preserving time. If yes, go to step S1120; otherwise, go to step S1100;

S1120: Delete the image file and the identification code corresponding to the image file.

Please note that an image accessing operation could be activated according to users' requirement as the storage time is calculated simultaneously. In this way, the scanned image file could be transmitted to a terminal device.

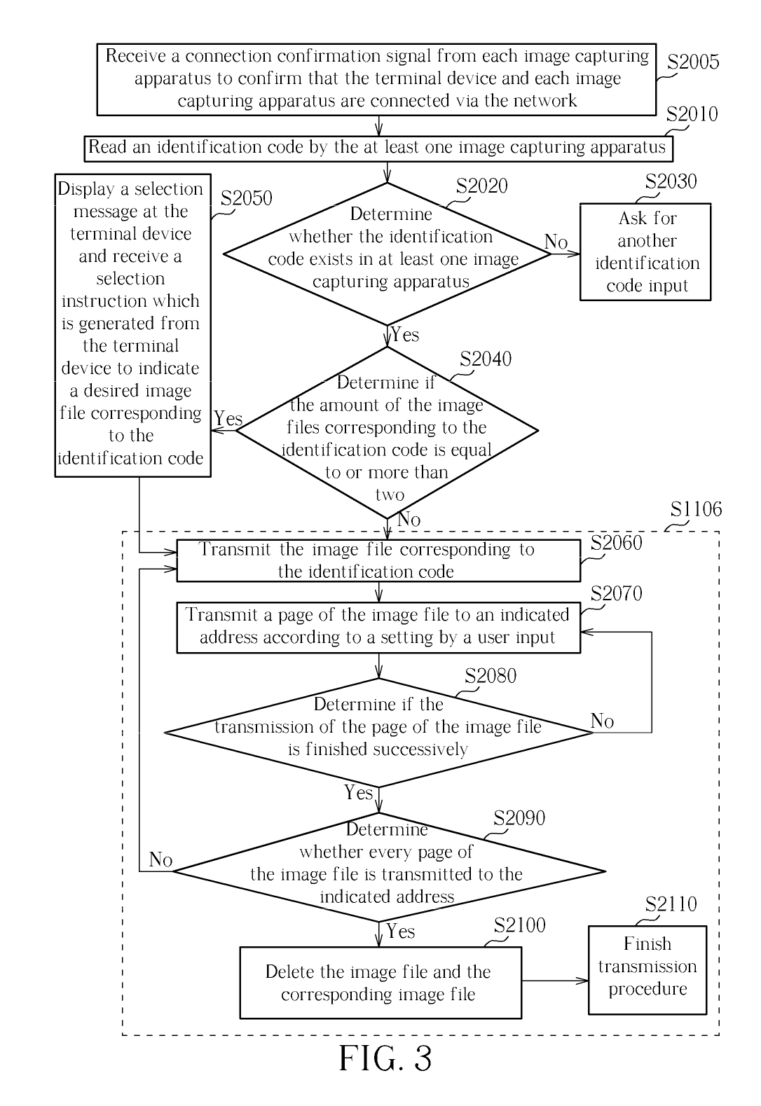

Please refer to FIG. 3. FIG. 3 is a flowchart of an image accessing method via a network according to the present invention. If the result is substantially the same, the steps are not required to be executed in the exact order shown in FIG. 3. In addition, the steps in FIG. 3 are not required to be executed sequentially, i.e., other steps can be inserted in between. The steps of the image accessing method according to the present invention are detailed as follows:

S2005: Receive a connection confirmation signal from each image capturing apparatus to confirm that the terminal device and the each image capturing apparatus are connected via the network;

S2010: Read an identification code by the at least one image capturing apparatus;

S2020: Determine if the identification code exists in the at least one image capturing apparatus? If yes, go to step S2040; otherwise, go to step S2030;

S2030: Ask for another identification code input again;

S2040: Determine if the amount of the image files corresponding to the identification code is equal to or more than two. If yes, go to step S2050; otherwise, go to step S2060;

S2050: Display a selection message at the terminal device and receive a selection instruction to indicate a desired image file corresponding to the identification code;

S2060: Transmit the image file corresponding to the identification code;

S2070: Transmit a page of the image file to an indicated address according to a setting by a user input;

S2080: Determine if the transmission of the page of the image file is finished successively. If yes, go to step S2090; otherwise, go to step S2070;

S2090: Determine whether every page of the image file is transmitted to the indicated address. If yes, go to step S2100; otherwise, go to step S2060;

S2100: Delete the image file and the corresponding image file;

S2110: Finish transmission procedure.

Please refer to FIG. 1 in conjunction with FIG. 2 and FIG. 3. After the image capturing apparatus 300 is activated, the image capturing apparatus 300 determines that whether a storage space of the storage 310 is sufficient (step S1010, S1020). If the storage space of the storage 310 is insufficient, the display module 340 will display a message of insufficient storage space to inform the user(s) of the image capturing apparatus 300. If the image capturing apparatus 300 receives an identification code IMG_ID which is not repeated as the identification codes already stored in the storage 310, the control module 330 stores the identification code IMG_ID in the storage 310 (step S1065); otherwise, the control module 330 will control the display module 340 to display a message of identification code repetition, and ask the user(s) of the image capturing apparatus 300 to input another identification code again (step S1060). In addition, the identification code IMG_ID corresponding to the image file IMG can be generated by the image capturing apparatus 300.

Subsequently, when the user(s) activates an image capturing function of the image capturing apparatus 300, e.g., a scanning function, the image capturing module 320 starts to capture an image of a document, which could be one page or multiple pages, to generates the image file IMG corresponding to the identification code IMG_ID, and the image capturing module 320 thereby stores the image file IMG in the storage 310 (step S1070, 1080). The image of the document can be captured into one or more pages. Afterward, the control module 330 receives an image preserving time T which is set by user(s). If the image preserving time T is not received, the control module 330 sets the image preserving time T by a default value (step S1090). As the image file IMG is being written in the storage 310, the control module 330 simultaneously starts counting time to calculate a storage time of the image file IMG stored in the storage 310. Besides, as the control module 330 calculates the storage time of the image file IMG, the control module 330 starts detecting if an image accessing operation of the image file IMG is to be activated (step S1100, S1105). On the other hand, if the image file IMG is not successively transmitted to an indicated address by a user input before the storage time of the image file IMG reaches the image preserving time T, i.e., the image accessing operation of the image file IMG is not executed before the storage time of the image file IMG reaches the image preserving time T, the control module 330 thereby controls the storage 310 to delete the image file IMG and the corresponding identification code IMG_ID to save storage space.

After the image capturing apparatus 300 finishes the capture operation of the document, the user(s) could load and execute a specific software (e.g., a computer program PROG) at the terminal device 400 (e.g., a personal computer) to initialize an image accessing operation via an internet according to the present invention. First, the terminal device 400 receives a confirmation signal from each image capturing apparatus, e.g., an image capturing apparatus 300 in this embodiment, to confirm that the terminal device 400 and each image capturing apparatus are connected via the network 500 (step S2005).

In step S2010, the terminal device 400 receives an identification code (e.g., identification code IMG_ID) inputted by the user(s). Subsequently, the terminal device 400 sends an identification code searching instruction to at least one image capturing apparatus connected with the terminal device 400 via the internet 500, the at least one image capturing apparatus thereby searches the identification codes stored in the at least one image capturing apparatus according to the identification code searching instruction to determine that if the identification code IMG_ID inputted by the user(s) exists in the at least one image capturing apparatus.

If one of the at least one image capturing apparatus, i.e., the image capturing apparatus 300 in this example, has the identification code IMG_ID, the at least one image capturing apparatus which has the identification code IMG_ID will activate an image accessing operation and transmit an image file IMG corresponding to the identification code IMG_ID to an indicated address by a user input, e.g., the storage 310 transmits the image file IMG to the terminal device 400 (step S2060). In this embodiment, the image capturing apparatus 300 will transmit each page of the image file of the document to the indicated address of the terminal device 300 or the other device (not shown) until every page of the image file is transmitted (step S2070, S2080 and S2090). In addition, in this embodiment, after the image capturing apparatus 300 successively transmits one page of the image file IMG corresponding to the identification code IMG_ID, the control module 330 deletes the transmitted image data of the page of the image file IMG to save storage space; when every page of the image file IMG is transmitted, the control module 330 deletes the identification code IMG_ID. Otherwise, the image file IMG and the corresponding identification code IMG_ID in the storage 310 are deleted after every page of the image file IMG is successively transmitted by the image capturing apparatus 300 (step S2100).

Besides, if the terminal device finds that the amount of the image files corresponding to the same identification code is equal to or more than two according to the searching results, the terminal device 400 displays a selection message which comprises an address of the each image capturing apparatuses storing the image files corresponding to the same identification code, the user(s) thereby could select desired image file according to the selection message comprising a correct address (step S2040, S2050).

Please note that step S2060˜2110 shown in FIG. 3 are exactly the image capturing operation activated in step S1106 in FIG. 2. Besides, one embodiment of the present invention is to load and execute a computer program PROG via the terminal device 400 to activate the image capturing operation via the internet 500 (step S2005˜S2050), therefore, the terminal device 400 is able to activate an image access procedure (step S1106) via the image capturing apparatus 300 to receive the image file IMG corresponding to the identification code IMG_ID from the image capturing apparatus 300.

From the descriptions above, the present invention provides a method of capturing image and accessing captured image via a network. The method of capturing image and accessing captured image via the network includes receiving a network scan instruction to initialize a image capturing operation to generate an image file of a document, and receiving an identification code corresponding to the image file to initialize an image accessing operation to transmit the image file from the image capturing apparatus to a terminal device. In this way, the user(s) no longer need to suffer from the complicated setting and there is no need to activate a sharing function of a file folder at the personal computer, leading to a significant improvement in utility convenience and security.

Those skilled in the art will readily observe that numerous modifications and alterations of the device and method may be made while retaining the teachings of the invention.

What is claimed is:

1. A method of capturing an image file and accessing the image file via a network, for an image capturing apparatus which has a storage and is connected to the network, comprising:
receiving a network scan instruction to initialize an image capturing operation, the image capturing operation comprises:
scanning a document and generating the image file and storing the image file in the storage;
receiving an identification code corresponding to the image file; and
storing the identification code in the storage;
receiving the identification code corresponding to the image file to initialize an image accessing operation, the image accessing operation comprises:
searching for the identification code; and
transmitting the image file corresponding to the identification code via the network.

2. The method of claim 1, wherein the image capturing operation further comprises:
displaying a message of insufficient storage space on a display module of the image capturing apparatus when there is no sufficient space in the storage for storing the image file.

3. The method of claim 1, wherein the steps of receiving the identification code further comprise:
displaying a message of repeated identification code on a display module of the image capturing apparatus when the identification code is the same with another one stored in the storage.

4. The method of claim 1, further comprising:
receiving an image preserving time; and
deleting the image file and the identification code corresponding the image file in the storage when a storage time of the image file stored in the storage reaches the image preserving time.

5. The method of claim 1, further comprising:
deleting the image file and the corresponding identification code in the storage when the image file is successively transmitted to an indicated address.

6. A computer program for accessing a captured image from at least one image capturing apparatus, loaded via a terminal device to process:
instructing the terminal device to receive an identification code;
instructing the terminal device to send an identification code searching instruction to the at least one image capturing apparatus connected to the terminal device via a network;
instructing the at least one image capturing apparatus to search for the identification code stored therein by the identification code searching instruction;
instructing one of the at least one image capturing apparatus to transmit an image file corresponding to the identification code;
instructing the terminal device to receive the image file corresponding to the identification code.

7. The computer program of claim 6, further comprising:
instructing the terminal device to receive a connection confirmation signal from the at least one image capturing apparatus to confirm that the terminal device and the at least one image capturing apparatus are connected via the network.

8. The computer program of claim 6, further comprising:
instructing the terminal device to receive a search result signal, when amount of the image files corresponding to the identification code is equal to or more than two, instructing the terminal device to display a selection message;
wherein the selection message comprises an address of each image capturing apparatus that stores the identification code.

9. The computer program of claim 8, wherein after the step of displaying the selection message, comprises:
instructing the terminal device to receive a selection instruction to indicate the desired image file corresponding to the identification code.

10. An image capturing apparatus, comprising:
a storage;
a image capturing module, coupled to the storage, for capturing an image of a document to generate an image file and thereby store the image file in the storage; and
a control module, coupled to the storage, for receiving an identification code corresponding to the image file and storing the identification code in the storage, thereby using the identification code to search for the image file corresponding to the identification code, and transmitting the image file corresponding to the identification code via a network.

11. The image capturing apparatus of claim 10, further comprising a display module, coupled to the control module, the display module displays a message of insufficient storage space when there is no sufficient space in the storage for storing the image file.

12. The image capturing apparatus of claim 10, further comprising a display module, coupled to the control module, the display module displays a message of repeated identification code when the identification code is the same with another one stored in the storage.

13. The image capturing apparatus of claim 10, wherein:
the control module is further used to receive an image preserving time; and
the control module controls the storage to delete the image file and the identification code corresponding the image file when a storage time of the image file stored in the storage reaches the image preserving time.

14. The image capturing apparatus of claim 10, wherein the control module deletes the image file and the corresponding identification code in the storage when the image file is successively transmitted to an indicated address.
